(19) United States
(12) Patent Application Publication
(10) Pub. No.: US 2003/0175456 A1
(43) Pub. Date: Sep. 18, 2003

(54) Beverage infustion packagaes and materials therefor

(76) Inventors: Nicholas Robin Whittaker, Lancashire (GB); Glynn Arthur Wardle, Bolton (GB); John Edward Rose, Chorley (GB)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/275,726

(22) PCT Filed: May 16, 2001
(86) PCT No.: PCT/GB01/02129

(30) Foreign Application Priority Data
May 16, 2000 (GB) 0011726.7

(51) Int. Cl. B29D 22/00; B29D 23/00; D04H 3/00; D04H 5/00

(52) U.S. Cl. 428/36.5; 442/327; 428/36.1

(57) ABSTRACT

A non-woven porous, fibrous tissue for use in producting beverage infusion packages (e.g. tea bags) incorporates lyocell fibres (most preferably unfibrillated) to improve transparency.

The present invention relates to porous, fibrous web materials for use in producing beverage infusion packages (e.g. tea bags, coffee bags and the like) as well as to beverage infusion packages produced using such materials.

Beverage infusion packages comprise a particulate beverage precursor material, e.g. tea leaves or ground coffee, in a bag, sachet, pouch or the like (all conveniently referred to herein as a bag) of a porous, fibrous (usually cellulosic) material. This material typically has a basis weight of 10 to 30 g m⁻² and is often referred to as “tissue” or “tissue paper”.

To produce a beverage, the package is infused with hot water. This may be done, for example, by immersing the package in hot water, pouring hot water onto the package, or heating water and the bag in a microwave oven.

The infusion package may be of a size, and contain an amount of the beverage precursor material, so as to be intended for producing a single cup of the beverage. Alternatively the package may be of a “catering size” and as such intended to produce a plurality of servings of the beverage. Such a “catering size” package may for example contain ground coffee as the beverage precursor material and be used in a commercial coffee-making machine.

The tissue may be of the “heat seal” or “non-heat seal” type.

“Heat seal” tissue usually (but not necessarily) comprises two layers (i.e. a dual phase product) or more than two layers wet-laid in succession one on top of the other. One layer incorporates thermoplastic fibres (e.g. polypropylene) and the other incorporates only thermally inactive materials. A beverage lion package is produced from such tissue by forming the bag such that layers if the tissue incorporating thermoplastic fibres are juxtaposed and then heat sealed.

“Non-heat seal” tissue generally (but not necessarily) comprises a single wet-laid layer of cellulosic fibres produced from mixtures of well known paper-making fibres which may include both woody and non-woody materials, e.g. manila hemp, sisal, jute, bleached and unbleached soft wood and hard wood species and in some instances approved synthetic fibres such as viscose rayon.

Beverage infusion packages (e.g. tea bags) produced from such “non-heat seal” material incorporate a seam formed by a mechanical compression action (e.g. involving crimping). Examples of such packages are those of the “double-chamber” type having attached string and tag as produced by both Constanta and Perfecta machines the world over.

The tissue is typically manufactured by the wet laid process on an inclined wire paper-making machine.

There is a disadvantage with the tissue conventionally used for the production of infusion packages, especially dual phase, in that it is relatively non-transparent so that the quality of the tea or other beverage precursor material in the package is not readily visible. As a result, consumer perception is that tea utilised in tea bags is fine particulate, poor quality tea since the consumer cannot see otherwise, at least not without opening one of the packages. Even if the tea within the bag is high quality, large leaf tea this will not be readily apparent due to the low transparency of the tissue so that consumer perception remains that inferior quality tea has been used.

There are currently available many woven polyester or nylon meshes/screens which are significantly more transparent than current tissues used for producing beverage infusion packages and, when used for such packages, allow the consumer to see the quality of the tea or other beverage precursor in the bag. However these woven products have a disadvantage in that they will not convert on standard heat seal machinery used for producing beverage infusion bags since they comprise 100% thermoplastic fibres which adhere to the contact heat sealing dies. As a result, modified machinery employing non-contact ultra-sonic welding guns has to be used in order to produce beverage infusion packages from these mesh/screen materials. However such modified machines have a much reduced throughput rate of 80 to 100 packages/minute as compared to current modern machines for producing beverage infusion packages from conventional heat seal tissue which have throughput rates of 800 to 3000 packages/minute. Therefore bags produced from the woven mesh materials have a much higher cost base and need dedicated conversion machinery.

Furthermore, such screen/mesh materials are not suitable for use in formation of non-heat seal beverage infusion bags since the mechanically formed seams do not have adequate strength.

It is therefore an object of the present invention to obviate or mitigate the above mentioned disadvantages.

According to the present invention there is provided a non-woven porous, fibrous tissue for use in producing beverage infusion packages, wherein said tissue comprises lyocell fibres to improve transparency.

According to a second aspect of the invention there is provided a beverage infusion package comprising a bag of a non-woven porous, fibrous tissue as defined in the previous paragraph, and a beverage precursor material contained within the bag.

The production of lyocell is described in U.S. Pat. No. 4,246,221 and involves dissolution of cellulose in a solvent and spinning the resultant dope into a coagulation bath to precipitate the cellulose and wash solvent from the fibre. Typically the solvent is a tertiary amine oxide, preferably N-methylmorpholine N-oxide (possibly in admixture with water) and the coagulation bath is aqueous.

We have found that the inclusion of lyocell fibres in tissue to be used for producing beverage infusion bags significantly improves transparency so that the contents of beverage infusion packages produced therefrom are readily visible. As a result the consumer can readily visually discern the quality of the beverage precursor material in bag.

Beverage infusion packages (e.g. tea bags) may be produced from tissue in accordance with the invention on standard converting machinery at throughput rates commensurate with those achieved using conventional tissue with seals/seams of adequate strength.

It is preferred that lyocell fibres for use in the invention are circular cross-section and alternatively or additionally do not contain titanium dioxide which would cause light scattering resulting in reduced transparency. It is also preferred that the lyocell fibres are unfibrillated, i.e. not mechanically treated. Fibrillating the Lyocell does increase the dry tensile strength and the filtration characteristics of the tissue but deleteriously affects tissue transparency.

The lyocell fibres will preferably have a fibre length of 2 mm to 18 mm, more preferably 4 mm to 8 mm, and ideally about 5 mm.

Preferably the lyocell is from 1.4 dcTex to 4.4 dcTex, more preferably from 1.7 dcTex to 3.3 dcTex and most preferably from 2.2 dcTex to 3.0 dcTex, e.g. 2.2 dcTex to 2.6 dcTex, for optimum fibre coverage and light transmission.

The lyocell fibres will generally be the principal cellulosic component of tissue in accordance with the invention and, apart from floc see infra, may be the sole cellulosic component of the tissue.

Tissue in accordance with the invention will generally have a basis weight of 10 to 30 g m⁻² more preferably 10 to 20 g m⁻², even more preferably 10 to 18 g m², e.g. 12 to 17 g m⁻², and may be of either the “heat seal” or “non-heat seal” type. For preference the tissue will be a wet-laid material although production of the tissue as a dry laid material is also possible.

A heat seal tissue in accordance with the invention will most preferably comprise only a single layer as dual phase products substantially inhibit transparency. This single phase will incorporate both the lyocell fibres and thermally active fibres (generally of a synthetic polymer) for providing the heat seal properties whereby the tissue is able to be heat sealed to itself (as described above) for the purpose of forming the bag or infusion package.

The heat seal fibres are preferably homopolymer fibres and preferably melt (soften) at a temperature of 140-175° C. Preferably the heat seal fibres have a fineness of 0.9 dcTex to 3.3 dcTex, more preferably 1.4 dcTex to 2.6 dcTex, e.g. 2.0 to 2.6 dcTex or 2.0 to 2.4 dcTex.

Heat seal fibres having a length of preferably 2 to 8 mm, more preferably 4 to 6 mm and ideally 5 mm are particularly suitable.

The heat seal fibres are most preferably of circular cross-section for maximum light transmission and preferably do not contain titanium dioxide as a brightness additive since this causes light scattering and reduces transparency of the tissue.

The heat seal fibres may be of polypropylene and may provide 10% to 40%, more preferably 25% to 35% by weight of the, product.

It is preferred that the heat seal tissue incorporates 1% to 20%, more preferably 5% to 15% by weight of floc based on the weight of the product.

Flocs for use in the invention are heavily fibrillated fibres and for materials produced by a wet-laying technique on a papermaking machine (e.g. an inclined wire machine) act as an effective binder to provide “classic” wet web strength prior to drying and removing the non-woven tissue from the inclined wire forming fabric and provide dry web strength after drying the non-woven web. The floc will generally have a fibre length within the range 0.1 mm to 1.5 mm but preferably about 1.0 mm. At this fibre length, the area coverage of the fibre is significantly increased, compared to a typical fibrillated 5 mm fibre, by a combination of internal and external “cleaving” of the fibre wall surface. Generally the floc will have a SR value in the range 60° to 100°, more preferably 70° to 95°.

The floc may be of a cellulosic material, such as wood pulp, Manila hemp or Lyocell.

Inclusion of the floc at the levels indicated above does not adversely affect trasparency of the tissue which would however be affected by fibrillation of the lyocell fibres to provide improvements in tensile strength.

Alternatively or additionally the thermally active material may incorporate bicomponent synthetic plastics fibres comprised of a core and an outer sheath of significantly lower melting point than the core. The core may for example have a melting point of about 260° C. whereas that of the sheath may be 105° C. to 165° C., but preferably less than the melting/softening temperature of the heat seal fibres. Such bicomponent fibres may for example comprise a core of a polyester having a melting point of about 260° C. and sheath selected from polyethylene having a melting point of 110° C. to 135° C., polypropylene having a melting point of 145° C. to 165° C. or, most preferably, copolyester having a melting point of 105° C. to 135° C.

The incorporation of bicomponent (sheath and core) fibres in the tissue allows the production of the tissue to be optimised on the paper machine. This is due to the production of a partially fused thermoplastic reinforcing scrim within the tissue, which supports the delicate web during the water removal phase and optional coating stages.

The bicomponent fibres are preferably thermally bonded to each other at the cross-over points of these fibres during manufacture of the tissue (see infra) to give a significant increase in both dry and wet tensile strength without deleteriously affecting transparency of the tissue.

The bicomponent fibres may be incorporated in the product in an amount of 5% to 50% of product by weight thereof, more preferably 10% to 30% and most preferably 15% to 25% on the same basis.

The bicomponent fibres may have a fineness of 1.4 dcTex to 4.4 dcTex, more preferably 1.7 dctex to 3.3 dcTex and most preferably 2.2 dcTex to 2.6 dcTex. Fibre lengths of 2 mm to 8 mm, more preferably 4 mm to 6 mm and most preferably about 5 mm are appropriate. The fibres are most preferably of circular cross-section.

Dry tensile strength of the heat seal tissue can optionally be increased by inclusion of 1% to 20% by weight of the tissue of highly fibrillated manila fibres (preferably 20-40° SR, more preferably 20-30° SR). Inclusion of manila at levels above 20% by weight may decrease the transparency of the tissue. Preferably the amount of the fibrillated manila does not exceed 16% by weight.

The heat seal tissue may optionally comprise both a thermally active layer (i.e. one incorporating the heat seal fibres) and a thermally inactive or insulating layer although this is not preferred, due the reduction in transparency, but the use of un-fribrilated Lyocell cellulose fibres does indeed reduce the loss of light transmission caused by traditional insulation layer fibres. In this case, the former preferably comprises 65% to 97% by weight of the heat seal tissue and the latter 3% to 35% on the sarne basis. More preferably the former comprises 79% to 93% and the latter 7% to 21% on the same basis. Most preferably the heat seal tissue comprises 83% to 90% by weight of the thermally active layer and 10% to 17% by weight of the insulating layer.

If the heat seal tissue incorporates a thermally inactive layer then this preferably comprises lyocell fibres and floc, preferably in amounts of 70% to 95% by weight lyocel and 5% to 30% by weight floc, most preferably about 85% by weight Iyoceu and about 15% by weight floc. For the insulating layer, the lyocell fibres are preferably shorter than those in the thermally active layer and may have a length of 0.5 mm to 5 mm, preferably 1 mm to 3 mm.

The invention has so far been described in detail with particular reference to the heat seal tissue. It is however also applicable to tissue of the non-heat seal variety. In this case, the tissue may comprise lyocell fibres as described and at least one of either floc or manila fibres as described above. Generally a non-heat seal tissue will comprise

| Component | Range | Typical |
|---|---|---|
| Lyocell Fibres | 80%-90% | 80% |
| Floc | 10%-20% | 10% |
| Manila Fibres | 5%-20% | 10% |

Tissue in accordance with the invention (whether of the heat seal or non-heat seal type) is most preferably produced by wet-laying employing technique well established in this field. The tissue may for example be produced on an inclined wire papermaking machine.

If the tissue comprises a thermally active layer and an insulating layer then these may be laid in either order.

If the tissue is produced by a wet-laying technique then it most preferably includes floc as described above and preferably also the bicomponent fibres. If the latter fibres are included then they will be thermally bonded during the first stage drying section on the papermaking machine improving run-ability and resulting in a significant increase in both and dry wet tensile strength of the tissue without deleteriously affecting transparency of the tissue.

The tensile strength of a wet laid product can be increased by coating (e.g. using a size press, blade coater, gravure printing press etc.) with a solution of a starch, or poly(vinyl)alcohol (95-99% hydrolysed) or latex (preferably a food approved SBR) or a cellulose ether, e.g. selected from methyl cellulose, ethyl cellulose, hydroxyethyl cellulose, propyl cellulose, hydroxypropyl cellulose but most preferably carboxymethyl cellulose, at a level of 0.5% to 3%, more preferably 1% to 2% by weight of the tissue. The inclusion of the starch, PVOH, Latex or cellulose ether increases dry and wet tensile strength without deleteriously affecting tissue transparency, and will generally be found to be necessary when infusion packages produced from the tissue are to be used for microwave brewing. However, in the case of a heat seal tissue, increasing the level of starch, PVOH, Latex or cellulose ether above 3% may adversely affect heat seal ply bond strength and is to be avoided.

The wet tensile strength of the product can be further improved by the addition of food approved “classical” wet strength resins such as Epochlorohidrin (Trade Mark Kymene) or Melamine formaldehyde (Trade mark Beetle Resin) at a level of 0.5 4% by weight of product.

Tissue in accordance with the invention may alternatively be produced by a dry-laying technique, in which case it will be preferred that the tissue incorporate bicomponent fibres and optionally floc, both as described above.

Beverage infusion packages (e.g. tea bags or coffee bags) may be produced from tissue in accordance with the invention on standard converting machinery at throughput rates commensurate with those achieved using conventional tissue.

The invention is illustrated by the following non-limiting Examples. In the Examples, the tissues were manufactured on a pilot paper machine. Transparency of the tissue was measured at 445 nm with the tissue clamped between two glass plates and is expressed as a percentage of the value obtained (at the same wave length) using the glass plates but without the tissue. Tissue was converted to tea bags on industrial standard tea bag conversion machines.

### EXAMPLE 1

A single Phase wet-laid heat seal tissue having a basis weight of 14.5 g m⁻² was prepared from a furnish comprising

| Component | % by weight |
|---|---|
| Lyocell fibres (5 mm, 2.8 dcTex) | 30.0% |
| ¹Polypropylene fibres (5 mm, 2.4 dcTex) | 28.0% |
| ²Sheath and Core fibres (5 mm, 2.4 dcTex) | 16.0% |
| Bleached Softwood Floc | 12% |
| Manila Fibres (24 SR) | 8% |
| Moisture | 6.0% |

¹Fibervision T153
²Kuraray N720

The fibrous web was treated with 3.0% by weight melamine and size pressed with 1.90% carboxymethyl cellulose.

The resultant product had a transparency of 38.5% and converted at satisfactory speeds on standard tea-bag manufacturing machinery to give tea bags with adequate seal strengths.

The tea within the bags was visible so that its physical characteristics (size etc.) could easily be determined.

### EXAMPLE 2

A dual phase heat tissue was produced from a furnish comprising

| Component | % by weight |
|---|---|
| Base Phase | |
| Lyocell fibres (5 mm, 2.8 dcTex) | 20.0% |
| ¹Polypropylene fibres (5 mm, 2.4 dcTex) | 28.0% |
| ²Sheath and Core fibres (5 mm, 2.4 dcTex) | 16.0% |
| Bleached Softwood Floc | 8% |
| Manila Fibres (24 SR) | 8% |
| Top Phase | |
| Bleached Softwood Floc | 4% |
| Lyocell fibres (5 mm, 2.8 dcTex) | 10.0% |
| Moisture | 6.0% |

¹Fibervision T153
²Kuraray N720

The fibrous web was treated with 3.0% by weight melamine and size pressed with 1.90% carboxymethyl cellulose.

The product obtained has a transparency of 27.5% and also converted well on standard tea bag manufacturing apparatus to give tea bags with adequate seal strength. However, the transparency of the tissue reduced by some 11% compared to that of Example 1 but was still significantly better than the standard product and produced a tissue that was sufficiently transparent for the physical characteristics of the tea within the bag to be distinguished.

### EXAMPLE 3

A single phase product was produced from a modification of the furnish employed in Example 1, the sheath and core fibres being omitted so as aid transparency. The furnish employed in this Example comprised

| Component | % by weight |
|---|---|
| Lyocell fibres (5 mm, 2.8 dcTex) | 44.0% |
| ¹Polypropylene fibres (5 mm, 2.4 dcTex) | 28.0% |
| Bleached Softwood Floc | 12% |
| Manila Fibres (24 SR) | 10% |
| Moisture | 6.0% |

¹Fibervision T153
²Kuraray N720

The fibrous web was treated with 3.0% by weight melarnine and size pressed with 1.90% carboxymethyl cellulose.

The product obtained had a transparency of 41.5% and also converted well on standard tea bag manufacturing apparatus to give tea bags with adequate seal strength. The transparency of the tissue was increased by some 8% over that of Example 1 and this produced a much greater increase in the ability to distinguish the tea quality in the bag than the data change might suggest

### COMPARATIVE EXAMPLE 4

A conventional dual phase heat seal tea bag tissue was produced from the following furnish:

| Component | % by weight |
|---|---|
| Base Phase | |
| ¹Polypropylene fibres (5 mm, 2.4 dcTex) | 25.0% |
| Bleached Softwood Floc | 4% |
| Manila Fibres (24 SR) | 31% |
| Top Phase | |
| Bleached Softwood Floc | 34% |
| Moisture | 6.0% |

¹Fibervision T153
²Kuraray N720

The fibrous web was treated with 3.0% by weight melamnine and size pressed with 1.90% carboxymethyl cellulose.

The tissue had a transparency of 19.0% and also converted well on standard tea bag manufacturing apparatus to give tea bags with adequate seal strength However, the transparency of the tissue is vastly inferior to the invention in any of its incarnations at some 19.5% less transparent than the preferred single phase embodiment which makes it almost impossible to distinguish the tea quality in the bag.

1. A non-woven porous, fibrous tissue for use in producing beverage infusion packages, wherein said tissue comprises lyocell fibres to improve transparency.

2. A tissue as claimed in claim 1 wherein the lyocell fibres are of circular cross-section.

3. A tissue as claimed in claim 1 or 2 wherein the lyocell fibres do not contain titanium dioxide.

4. A tissue as claimed in any one of claim 1 to 3 wherein the lyocell fibres have a fibre length of 2 mm to 18 mm.

5. A tissue as claimed in claim 4 wherein the lyocell fibres have a fibre length of 4 mm to 6 mm.

6. A tissue as claimed in any on claims 1 to 5 wherein the lyocell is from 1.4 dcTex to 4.4 dcTex.

7. A tissue as claimed in claim 6 wherein the lyocell is from 1.7 dcTex to 3.3 dcTex.

8. A tissue as claimed in claim 7 wherein the lyocell is from 2.6 dcTex to 3.0 dcTex.

9. A tissue as claimed in any one of claim 1 to 8 wherein the lyocell fibres are unfibrillated.

10. A tissue as claimed in any of claims 1 to 9 wherein the lyocell fibres are the principal cellulosic component of the tissue.

11. A tissue as claimed in any one of claims 1 to 10 having a basis weight of 10 to 30 g m⁻².

12. A tissue as claimed in claim 11 wherein the basis weight is 10 to 20 g m⁻².

13. A tissue as claimed in claim 12 wherein the basis weight is 10 to 18 g m⁻².

14. A tissue as claimed in claim 13 wherein the basis weight is 12 to 17 g m⁻².

15. A tissue as claimed in any one of claims 1 to 14 which is a heat seal tissue incorporating heat seal fibres.

16. A heat seal tissue as claimed in claim 15 incorporates heat seal fibres that melt (soften) at a temperature of 145-175° C.

17. A tissue as claimed in claim 15 or 16 wherein the heat seal fibres have a fineness of 0.9 dcTex to 3.3 dcTex.

18. A tissue as claimed in claim 17 wherein the heat seal fibres have a fineness of 2.0 dcTex to 2.6 dcTex.

19. A tissue as claimed in any one of claims 15 to 18 wherein the heat seal fibres have a length of 2 to 18 mm.

20. A tissue as claimed in claim 19 wherein the heat seal fibres have a length of 4 to 6 mm.

21. A tissue as claimed in claim 20 wherein the heat seal fibres have a length of about 5 mm.

22. A tissue as claimed in any one of claims 15 to 21 wherein the heat seal fibres are of circular cross-section.

23. A tissue as claimed in any one of claims 15 to 22 wherein the heat seal fibres do not contain titanium dioxide.

24. A tissue as claimed in any one of claim 15 to 23 wherein the heat seal fibres comprise 10% to 40% by weight of the tissue.

25. A tissue as claimed in claim 24 wherein the heat seal fibres comprise 25% to 35% by weight of the tissue.

26. A tissue as claimed in any one of 15 to 25 incorporating 1% to 20% by weight of floc based on the weight of the tissue.

27 A tissue as claimed in any one of claims 15 to 26 incorporating synthetic plastics bicomponent fibres comprised of a core and a lower melting sheath.

28. A tissue as claimed in claim 27 wherein the bicomponent fibres are thermally bonded to each other at the cross-over points of these fibres.

29. A tissue as claimed in claim 27 or 28 incorporating 5% to 50% by weight of the bicomponent fibres based on the weight of the tissue.

30 A tissue as claimed in claim 29 incorporating 10% to 30% by weight of the bicomponent fibres based on the weight of the tissue.

31 A tissue as claimed in claim 30 incorporating 15% to 25% by weight of the bicomponent fibres based on the weight of the tissue.

32 A tissue as claimed in any one of claims 27 to 31 wherein the bicomponent fibres have a fineness of 1.4 dcTex to 4.4 dcTex.

33. A tissue as claimed in claim 32 wherein the bicomponent fibres have a fineness of 1.7 dcTex to 3.3 dcTex.

34. A tissue as claimed in claim 33 wherein the bicomponent fibres have a fineness of 2.2 dcTex to 2.4 dcTex.

35. A tissue as claimed in any one of claims 27 to 31 wherein the bicomponent fibres have a length of 2 mm to 18 mm.

36. A tissue as claimed in claim 35 wherein the bicomponent fibres have a length of 4 mm to 6 mm.

37. A tissue as claimed in any one of claims 15 to 36 which is a single phase tissue

38. A tissue as claimed in any one of claims 15 to 37 additionally comprising an insulating layer incorporating only thermally inactive fibres.

39. A tissue as claimed in claim 38 wherein the thermally active layer comprises 65% to 97% by weight and the insulating layer comprises 3% to 35% by weight, the percentages being based on the weight of the tissue.

40. A tissue as claimed in claim 39 wherein the thermally active layer comprises 79% to 93% by weight and the insulating layer comprises 7% to 21% by weight, the percentages being based on the weight of the tissue.

41. A tissue as claimed in claim to 40 wherein the thermally active layer comprises 83% to 90% by weight and the insulating layer comprises 10% to 17% by weight, the percentages being based on the weight of the tissue.

42. A tissue as claimed in any one of claims 38 to wherein the insulating layer comprises lyocell fibres and floc.

43. A tissue as claimed in claim 42 wherein the insulating layer comprises 70% to 95% by weight lyocell and 5% to 30% by weight floc.

44. A tissue as claimed in claim 43 wherein the insulating layer comprises about 85% by weight lyocell and about 15% by weight floc.

45. A tissue as claimed in any one of claims 42 to 44 wherein the lyocell fibres of the insulating layer have a length shorter than those of the thermally active layer.

46. A tissue as claimed in any one of claims 42 to 45 wherein the lyocell fibres of the insulating layer have a length of 0.5 mm to 5 mm.

47. A tissue as claimed in claim 46 wherein the lyocell fibres of the insulating layer have a length of 1 mm to 3 mm.

48. A tissue as claimed in any one of claims 1 to 14 which is a non-heat seal tissue.

49. A tissue as claimed in claim 48 comprising 80-90% by weight lyocell fibres and 10% to 20% by weight floc.

50. A tissue as claimed in claim 49 comprising about 85% by weight lyocell fibres and about 15% by weight floc.

51. A beverage infusion package comprising a bag of a tissue as claimed in any one of the previous claims and a beverage precursor material contained within the bag.

52. A package as claimed in claim 51 which is a tea bag.

53 A package as claimed in claim 51 which us a coffee bag.
